(19) United States
(12) Patent Application Publication
(10) Pub. No.: US 2009/0114823 A1
(43) Pub. Date: May 7, 2009

(54) RADIATION MEASURING DEVICE

(75) Inventors: Christian Pychlau, Freiburg (DE); Massimo Caccia, Milano (IT); Alexander Martemiyanov, Moscow (RU); Wojciech Kucewicz, Krakow (PL); Chiara Cappellini, Erba (Como) (IT); Valery Chmill, Brunate (Como) (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: PTW-Freiburg Physikalisch-Technische Werkstaetten, Dr. Pychlau GmbH, Freiburg (DE)

(21) Appl. No.: 12/257,430

(22) Filed: Oct. 24, 2008

(30) Foreign Application Priority Data
Nov. 2, 2007 (DE) 102007052268.3

(51) Int. Cl. G01T 1/20

(52) U.S. Cl. 250/361 R

(57) ABSTRACT

A radiation measuring device to determine the intensity and/or the dose of the ionizing radiation during a radiological examination of a patient is provided, with the radiation measuring device (1) being arranged in the radiation path between the radiation source and the patient. The radiation measuring device (1) is provided with at least one scintillator (7).

### CROSS-REFERENCE TO RELATED APPLICATIONS

This application claims the benefit of DE 10 2007 052 268.2, filed Nov. 2, 2007, which is incorporated herein by reference as if fully set forth.

### BACKGROUND

The invention relates to a radiation measuring device to determine the intensity and/or the dose of ionizing radiation during a radiological examination of a patient, with the radiation measuring device being arranged in a beam path between the radiation source and the patient.

Two types of examinations are distinguished in radiological diagnostics: the curative diagnostics for the targeted diagnosis after an initial suspicion and the so-called screening, in which examination occurs without any suspicion to detect any disease as early as possible.

However, it must always be observed in both types of radiological examinations that the ionizing radiation used can damage or destroy the examined tissue and thus lead to disease. Therefore it must be precisely assessed prior to any examination if any potential tissue damage by the radiation is acceptable in reference to a diagnosis benefiting the patient. Particularly during screening, the risks by radiation must be assessed very precisely.

Here, the decisive value is the dose absorbed by the tissue during the examination. This depends on the radiation emitted by the radiation source and the examined tissue itself, because various types of tissue are damaged by radiation to a different extent.

It is therefore important for planning or assessing an examination to know the precise dose of the radiation, particularly because the doses of several examinations occurring at different times accumulate.

Previously, radiation sources have been calibrated in regular intervals, with the dose being determined using a reference measuring device at a phantom body. However, with this methodology the dose of an examination with this radiation source can only be estimated. This dose can be recorded in a patient file or on the examination result, for example. In this manner, the previously absorbed overall dose is always known and can be considered for future examinations.

Particularly in a radiological examination of delicate tissue, such as for example during mammography, it would therefore be useful to directly know the exposure to radiation so that the actually absorbed dose can be determined.

For this purpose, a thermo-luminescence dosimeter (TLD) can be arranged between the radiation source and the breast. A special material capable of thermo-luminescence is arranged in the TLD absorbing the incident radiation. When the TLD is homogenously heated after the radiation it emits visible light with its intensity being proportional to the previous radiation intensity. The assessment of the TLD is therefore expensive and the measuring results are only available after the radiation and the evaluation. It is therefore impossible to adjust the radiation intensity based on the already accumulated dose during an ongoing examination or to terminate this examination early.

A real-time representation of the dose is possible, for example when using semi-conductor detectors that can directly measure the ionizing radiation. These detectors are only partially transparent with regard to the examined radiation, so that any measuring object located therebehind is shadowed and strong image artifacts develop. Any real-time measurement at the patient is therefore impossible with such detectors.

### SUMMARY

Therefore the object of the invention is to provide a radiation measuring device for ionized radiation which allows a real-time determination of the radiation intensity and/or dose directly at the patient during an ongoing radiological examination.

This Object is Attained According to the Invention in that the Radiation measuring device is provided with at least one scintillator.

Scintillators are commonly used to determine the intensity of gamma radiation. Both inorganic as well as organic substances are suitable as materials for scintillators. For example, sodium iodide doped with thallium is such an inorganic scintillator material.

Organic scintillators may comprise polyvinyl toluene, polystyrene, or polymethyl methacrylate, for example. These plastic scintillators must also be doped to allow light emissions.

Free charged particles are created in the scintillator by incident, energy-rich photons, which can change the atoms or molecules of the scintillator into an excited state. Due to the fact that beta-radiation itself includes energy-rich charged particles, the excitation of the atoms or molecules can occur by the radiation itself. The excited atoms or molecules return to their initial state after a short period of time and here release their energy in form of visible light.

In contrast to TLD, this fluorescence is spontaneous, this means the scintillator atoms return to their initial state after a few nano to micro seconds and the light emission occurs almost without any delay. This allows a measurement in real time and during an ongoing irradiation.

The emitted light intensity is here proportional to the energy deposited in the scintillating material by the incident radiation. It is therefore possible to determine the precise energy of the incident particles by measuring the fluorescent light.

Therefore the actual dose since the beginning of the radiation can be calculated and displayed by a continuous integration of the particle energy.

The radiation meter according to the invention is preferably provided with a plastic scintillator suitable to register X-Rays. Beneficially it is only a few tenths of a millimeter thick and additionally characterized in low absorption. This means that only few molecules are excited by the incident radiation. Accordingly, shading of the tissue sample positioned therebehind is only minor and the scintillator is practically invisible on the examination result, for example an X-Ray image.

This allows the radiation measurement during the radiological examination directly at the patient. Additionally it is possible to cancel the radiation when a certain dose has been reached. Furthermore, the precisely administered dose can be recorded in the patient file or on the result of the examination, for example the X-Ray image. For example, in a later examination the entire previously absorbed dose would be known and could be considered in the risk assessment as an absolute value. This would result in an enormous benefit with regard to safety, both for the patient as well as the treating physician in reference to the conventional assessment based on the type and number of radiological examinations performed in the current year.

The scintillator can be embodied rectangular or circular or semi-circular or also be formed differently, for example elliptical. Preferably the scintillator is formed as platelets embedded in a plastic element, for example made from Plexiglas. The thickness of the scintillator can here amount to a range of tenths of millimeters, preferably from 0.3 mm to 0.5 mm. In order to assess the radiated fluorescent light, the scintillator may comprise a light conductor so that the light radiated from the scintillator can irradiate into the light conductor and be relayed to a detector. Here, it is beneficial when the light conductor completely encircles the platelet once and when a photo-detector is arranged at least at one free end of the light conductor to measure the light intensity.

Another advantageous embodiment according to the invention provides that at least one scintillator is embodied as a scintillating light conductor. A conventional light conductor can be connected to this scintillating light conductor at least at one end of the conductor, relaying the light to at least one detector. Here it can be advantageous when the radiation measuring device has several preferably up to eight scintillating light conductors or conductive light fibers.

Beneficially the second end of the scintillating light conductor can be connected to a second photo-detector so that a higher sensitivity of the measuring setup is achieved. Due to the fact that the plastic scintillator has only a low yield, this arrangement allows a more precise measurement of the intensity of the fluorescent light.

However, it is also possible to form the radiation measuring device as an independent functional unit of the scintillator with the encircling light conductor that can be positioned freely via the compression plate. This also prevents any unnecessary shadowing of the tissue because no additional plastic element is located in the radiation path between the radiation source and the tissue.

Known semi-conductor detectors can be used in a photo-detector capable to determine the intensity of the fluorescent light.

The photo-detectors can here be arranged separately near the patient or be integrated in a display unit showing the dose and/or the actual radiation intensity.

Preferably the radiation meter according to the invention can be used in mammography, because here the risk to damage the breast tissue by the X-Rays used is particularly high and thus the risk must be assessed very precisely prior to the examination.

In mammography the breast tissue is usually held by a compression plate. Beneficially the scintillator can be arranged above or below the compression plate. Due to the fact that no electric connection to the scintillator is necessary and the plastic is well tolerated by the skin, any contact to the tissue is not a critical factor.

Another preferred embodiment variant provides that the scintillator is embedded in the compression plate so that the handling of the measuring device is facilitated because, except for the placement of the compression plate, no additional handling is necessary.

### BRIEF DESCRIPTION OF THE SEVERAL VIEWS OF THE DRAWINGS

In the following the invention is explained in greater detail using the drawings:

Shown are:

FIG. 1 is a view of a first arrangement of a radiation measuring device according to the invention,

FIG. 2 is a view of a second arrangement of the radiation measuring device,

FIG. 3 is a view of a third arrangement of the radiation measuring device,

FIG. 4 is a view of a proposed arrangement of the light conductor at the radiation measuring device,

FIG. 5 is a view of another proposed arrangement of the light conductor at the radiation measuring device,

FIG. 6 is a view of another embodiment variant of a radiation measuring device according to the invention having several scintillators, and

FIG. 7 is a schematic view of a measuring setup with the radiation measuring device according to the invention according to FIG. 1.

### DETAILED DESCRIPTION OF THE PREFERRED EMBODIMENTS

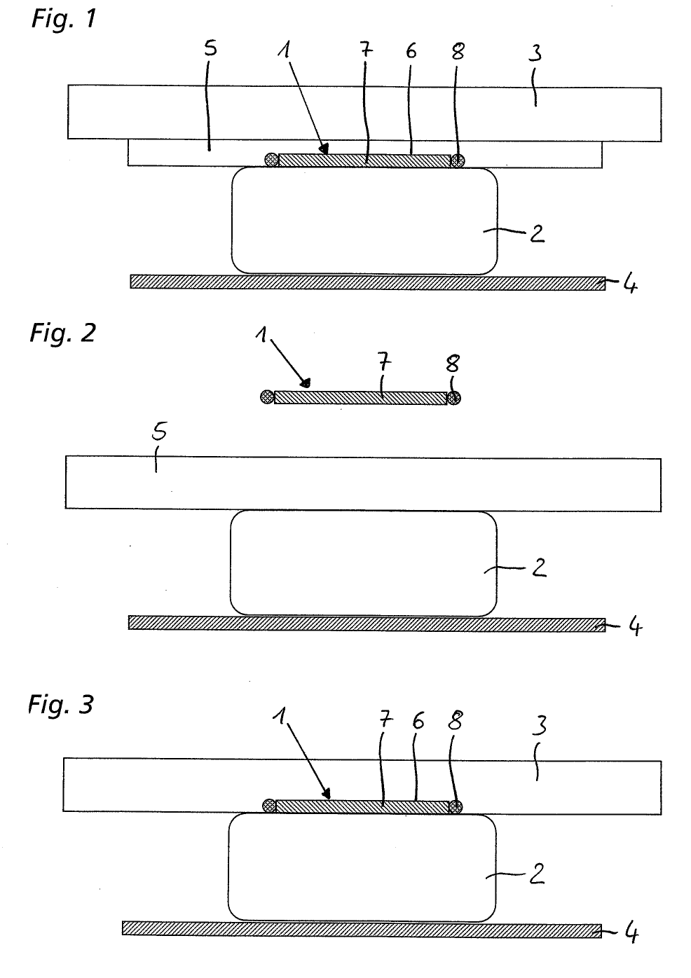

FIG. 1 shows an arrangement of a radiation measuring device, in its entirety marked 1, particularly for the use in mammography.

In mammography, the tissue 2 to be examined is pressed onto an X-Ray film holder 4 by a compression plate 3, in order to yield an image as free from vibrations as possible. According to the invention, a radiation measuring device 1 is arranged between the compression plate 3 and the tissue 2, which essentially comprises an approximately 1 mm thick plastic film 5, here a rectangular one, that is provided, approximately in the center, with a circular recess 6 measuring approximately 3 cm. A scintillator 7 is embedded flush in this recess, and is approximately 0.5 mm thick. The plastic film 5 and the scintillator 7 are made from X-Ray permeable plastic so that no excess shading of the X-Ray image develops.

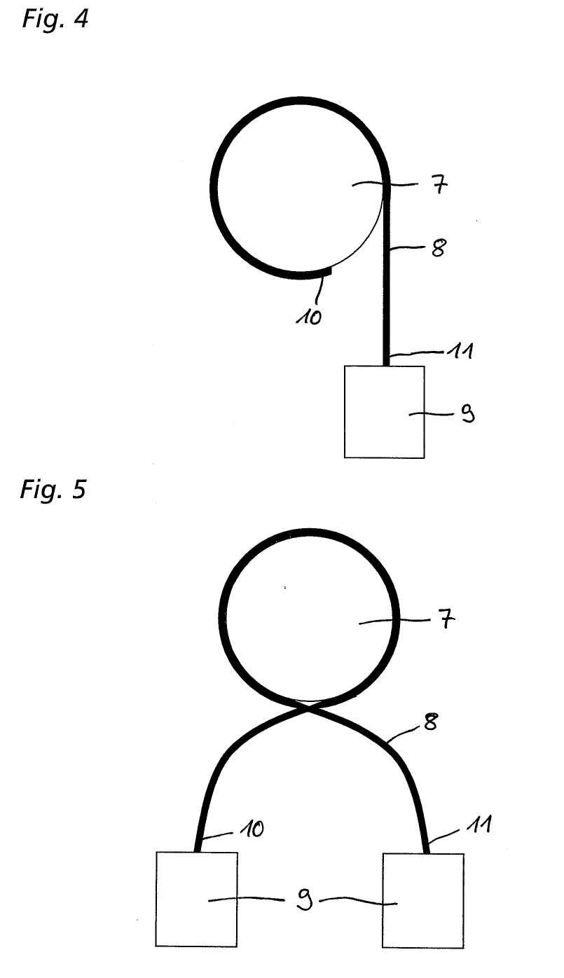

The scintillator 7 is encircled by a light conductor 8, embedded in the plastic film 5, which collects the fluorescent light emitted by the scintillator 7 and relays it to the detector 9. As shown schematically in FIG. 4, the light conductor 8 is essentially wound once around the scintillator 7. One end 10 of the light conductor 8 contacts the scintillator 7, here, while the free end 11 leads away from the scintillator 7, approximately tangentially, and is connected to a photo-detector 9 that determines the intensity of the fluorescent light.

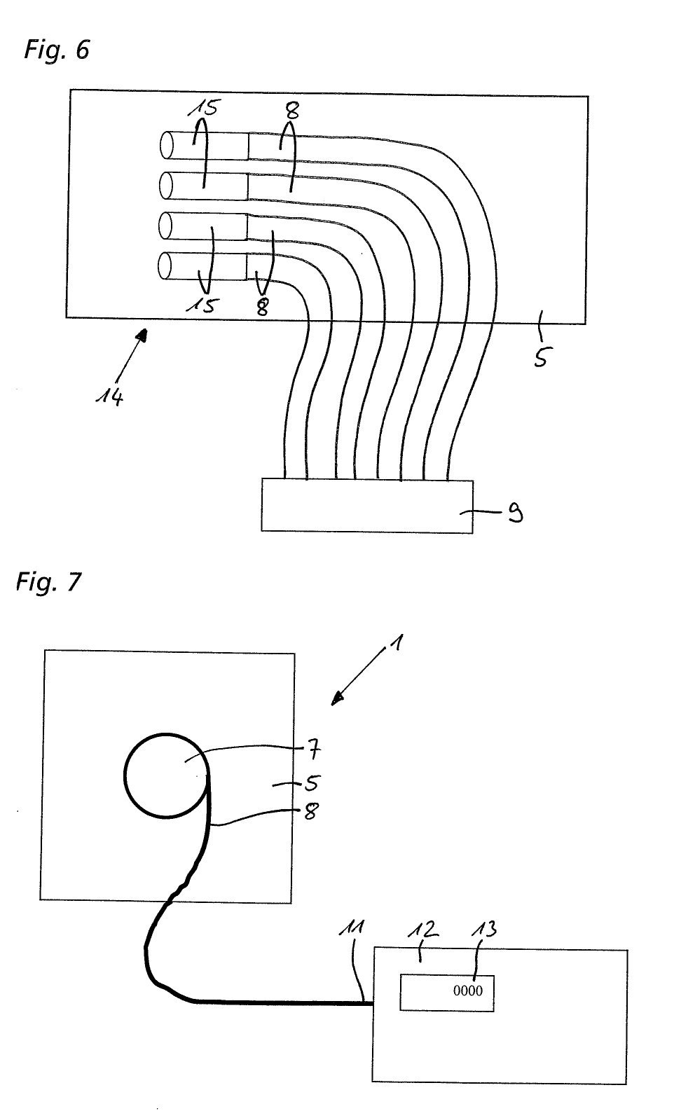

An alternative embodiment is shown in FIG. 5 in which the light conductor 8 is essentially wound once entirely around the scintillator 7 and the two conductor ends 10, 11 lead away from the scintillator 7. Both ends 10, 11 are each connected to a photo-detector 9 in order to produce a better yield and/or analysis of the fluorescent light of the scintillator 7.

The placement of the photo-detector 9 is not critical, here. It is possible to arrange the photo-detector 9 near the patient and to electrically connect it to the display unit 12, or as shown in FIG. 7, to integrate the photo-detector in the display unit 12 such that the signal transmission occurs exclusively in the light conductor 8. A display 13 is arranged at the display unit 12 where in real time the dose and/or intensity of the X-Ray radiation can be read.

Due to the fact that there are no electric contacts, either at the scintillator 7 or at the plastic film 5, the measuring device 1 can be placed directly on the skin of the patient without any concerns.

The arrangement of the radiation measuring device according to the invention shown in FIG. 2 differs from the one of FIG. 1 such that the radiation measuring device 1 is formed only from the scintillator 7 and the encircling light conductor 8. The radiation measuring device 1 is arranged freely above the compression plate 3, with a contact being possible but not necessary. This arrangement can be experienced as more comfortable by the patient because the scintillator 7 has no contact to the skin. Furthermore no unnecessary shading occurs due to any additional plastic film 5.

Deviating from FIG. 1, in the embodiment of FIG. 3 the radiation measuring device 1 is integrated directly in the compression plate 3 so that no separate plastic film 5 is necessary here, either. This embodiment facilitates the application of the measuring device 1 according to the invention because no additional film 5 must be placed on the tissue 2.

The radiation measuring device 14 shown in FIG. 6 is provided with four scintillators 15, embodied essentially cylindrically. Light conductors 8 to collect the fluorescent light and relaying it to a photo-detector 9 are arranged at one axial end of the scintillators 15 each. For easy handling, the scintillators 15 and the light conductors 8 are embedded in a rectangular plastic film 5, although it is understood that the plastic film 5 can have any other arbitrary form.

Preferably, the rod-shaped scintillators 15 are approximately 1 cm to 2 cm long and, compared to the thickness of the film, have a lower diameter in the range of tenths of millimeters.

In the exemplary embodiment shown, the scintillators 15 are produced from sections of a scintillating optic plastic fiber, which can easily be connected to the plastic light-conductors 8. It is also possible to use other scintillators in this arrangement, for example inorganic crystals.

Furthermore, this arrangement also allows varying the number of scintillators so that the plastic film can be arranged between one and eight scintillators, with the arrangement being selected freely. Deviating from the linear arrangement shown, star-shaped or any other arrangements are also possible.

The invention is not limited to the exemplary embodiments shown and described. Rather other arrangements of the radiation measuring devices according to the invention are also possible. Furthermore, the invention is also suitable to determine the dose of other radiological examinations, such as maxillary examinations.

1. A radiation measuring device to determine at least one of an intensity or a dose of ionizing radiation during a radiological examination of a patient in which the radiation measuring device (1; 14) is arranged in a radiation path between a radiation source and the patient, the radiation measuring device (1) comprises at least one scintillator (7; 15).

2. A radiation measuring device according to claim 1, wherein at least one optic light conductor (8) is provided at the at least one scintillator (7; 15) to collect fluorescent light signals originating in the at least one scintillator (7; 15) and the scintillator is connected to at least one detector (9) to evaluate the fluorescent light signals of the scintillator (7; 15).

3. A radiation measuring device according to claim 2, wherein the at least one scintillator is embodied as a scintillating light conductor.

4. A radiation measuring device according to claim 2, wherein the radiation measuring device comprises a plurality of the scintillating light conductors.

5. A radiation measuring device according to claim 2, wherein two ends of the optic light conductor (8) are each connected to a detector (9).

6. A radiation measuring device according to claim 1, wherein the scintillator (7) is approximately circular, semi-circular or rectangular.

7. A radiation measuring device according to claim 1, wherein the scintillator (7; 15) is produced from plastic.

8. A measuring device according to claim 2, further comprising a display device (12) that displays in real time at least one of the radiation intensity or the dose of the radiation source during the radiological examination.

9. A radiation measuring device according to claim 8, further comprising a compression plate (3) to hold the tissue (2) to be examined.

10. A radiation measuring device according to claim 9, wherein the scintillator (7; 15) is arranged above or below the compression plate (3).

11. A radiation measuring device according to claim 10, wherein the scintillator (7; 15) is integrated in a plastic element (5).

12. A radiation measuring device according to claim 11, wherein the plastic element is the compression plate (3).

13. A radiation measuring device according to claim 1, wherein the radiation source is an X-Ray source with an acceleration voltage ranging from approximately 18 kV to 35 kV.

14. A radiation measuring device according to claim 7, wherein the scintillator (7; 15) is produced from polystyrene.
